(19) United States
(12) Patent Application Publication
(10) Pub. No.: US 2021/0349516 A1
(43) Pub. Date: Nov. 11, 2021

(54) ENERGY SAVING DEVICE AND METHOD FOR SAVING ENERGY IN DATA CENTER

(71) Applicant: HONGFUJIN PRECISION ELECTRONICS(TIANJIN)CO.,LTD., Tianjin (CN)

(72) Inventors: CHENG-DA YANG, Neihu (TW); SHENG-CHUNG PAN, New Taipei (TW); CHIEN-SHENG YEH, Neihu (TW); YEN-HSUAN CHEN, New Taipei (TW)

(21) Appl. No.: 16/908,970

(22) Filed: Jun. 23, 2020

(30) Foreign Application Priority Data
May 9, 2020 (CN) 202010388603.9

(51) Int. Cl. G06F 1/3225; G06F 1/3287

(52) U.S. Cl. CPC G06F 1/3225; G06F 1/3287

(57) ABSTRACT

An energy saving method for a data center includes obtaining the operating conditions of a plurality of servers; determining whether the servers are in a first state according to the reading of conditions, and controlling the server in the first state to go into a second state. The disclosure also provides an energy saving device for a data center together with the method.

### FIELD

The subject matter herein generally relates to energy saving devices.

### BACKGROUND

A large number of servers can be deployed in some cabinets of the data center in order to provide various services. When these servers are operating, some unrelated servers may also be working, with low energy utilization and waste of energy.

Therefore, improvement is desired.

### BRIEF DESCRIPTION OF THE DRAWINGS

Implementations of the present disclosure will now be described, by way of embodiments, with reference to the attached figures.

FIG. 1 is a block diagram of an embodiment of an energy-saving device of the present disclosure.

FIG. 2 is a flowchart of an embodiment of a method for saving energy.

FIG. 3 is a flowchart of another embodiment of a method for saving energy.

FIG. 4 is a block diagram of an embodiment of an energy-saving system.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series, and the like.

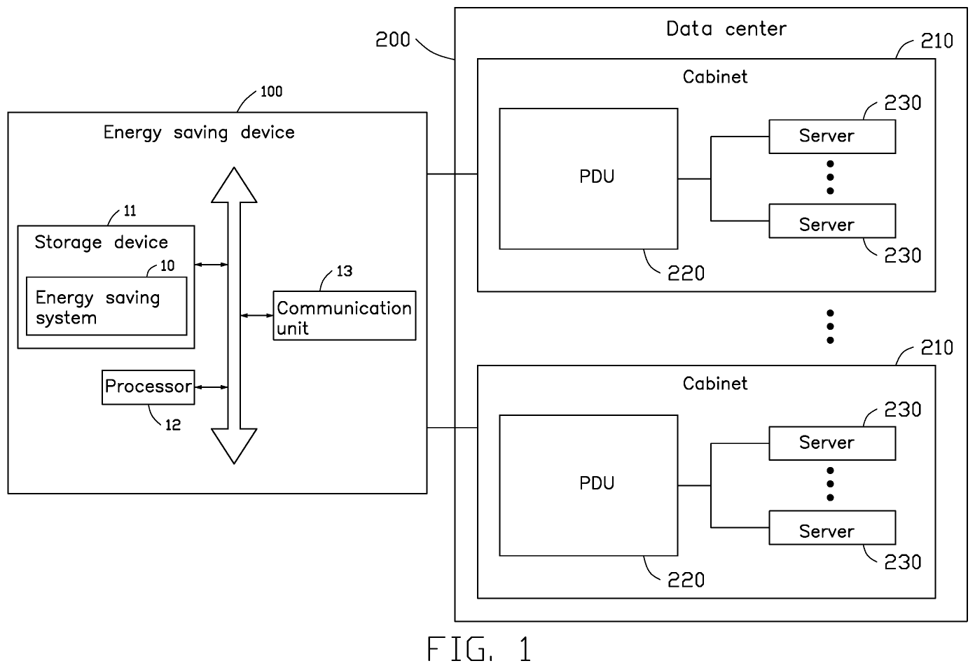

FIG. 1 illustrates an energy saving device 100 in accordance with an embodiment of the present disclosure. An energy saving system 10 runs in the energy saving device 100.

The energy saving device 100 is connected to a data center 200 via a communication network. The energy saving device 100 manages power usage of the data center 200.

In the embodiment, the data center 200 includes a plurality of cabinets 210. Each of the cabinets 210 includes a power distribution unit (PDU) 220 and a plurality of servers 230, and the PDU 220 can provide power to the servers 230.

The energy saving device 100 includes, but is not limited to, a storage device 11, a processor 12, and a communication unit 13. In the embodiment, the communication unit 13 is a data routing device, the communication unit 13 is connected to the plurality of cabinets 210 via a communication network. In the embodiment, the energy saving device 100 can be a computer.

The energy saving device 100 monitors operations of each of the servers 230, and determines whether energy saving operations need to be applied to the data center 200. When the energy saving operations are determined as being necessary for the data center 200, the energy saving device 100 can control the server 230 to enter a shutdown state, to avoid wasting electric energy.

In other embodiments, the energy saving device 100 can be connected to a mobile device (not shown), so that users can receive up-to-date server-related information.

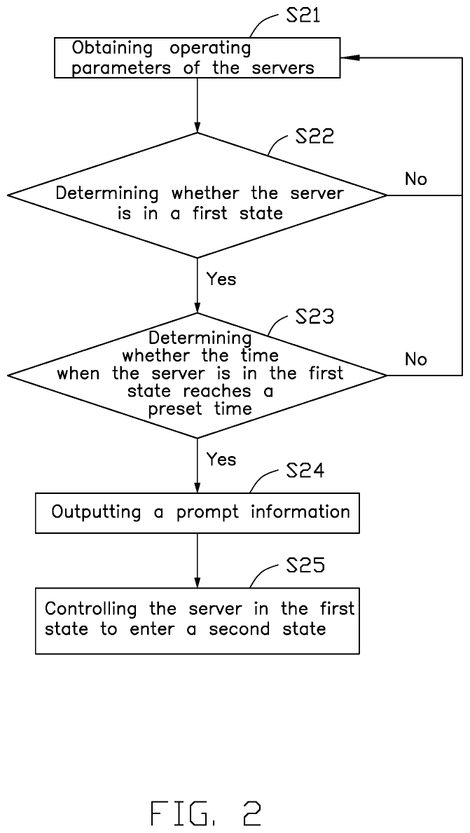

FIG. 2 illustrates a flowchart of a method for saving energy. The method for saving energy may include the following steps.

In block S21, operating parameters of the servers 230 are obtained.

In the embodiment, the operating parameters can include the power, IP address, host name list, power status, and system usage of each server 230. The system usage can include CPU utilization, available storage device value, disk utilization, and rate of the network sending or receiving data.

The energy saving system 10 obtains the operating parameters of the servers 230, and displays the operating parameters in real time. After the energy saving system obtains the operating parameters of the servers 230, the energy saving system 10 also stores the operating parameters.

In block S22, whether the server 230 is in a first state is determined. If the server 230 is in the first state, block S23 is implemented, otherwise returns to block S21.

In the embodiment, the energy saving system 10 determines whether the server 230 is in the first state according to the obtained operating parameters. In the embodiment, the first state is a standby state of the server 230.

When the CPU utilization of the server 230 is less than 10%, the value of available storage in the device is greater than 90%, the disk utilization is less than 10%, and the rate of the network sending or receiving data is less than 10MB/s, the energy saving system 10 determines that the corresponding server 230 is in the first state. The energy saving system 10 will determine that the server 230 is in the standby state.

If the operating parameters of the server 230 do not meet the conditions of the first state, and the server 230 is not in the standby state, the energy saving system 10 will obtain the operating parameters of the server 230. The energy saving system 10 can obtain the latest operating status of the server 230 in the data center 200.

In block S23, whether the period of time of the server 230 being in the first state reaches a preset time is determined. If the first state reaches the preset time, block S24 is implemented, otherwise returns to block S21.

In the embodiment, when the server 230 is determined to be in the standby state, the energy saving system 10 will determine whether the time when the server 230 is in the standby state reaches the preset time, for example, the energy saving system 10 determines whether the server 230 is in standby for 12 hours. It can be understood that the preset time is not a fixed value, and the preset time can be adjusted according to actual needs.

If the time when the server 230 is in the standby state does not reach the preset time, the energy saving system 10 will need to obtain the operating parameters of the server 230 again. The energy saving system 10 can obtain the latest operating status of the server 230 of the data center 200.

In block S24, information as a prompt is outputted.

In the embodiment, the energy saving system 10 will output a prompt information to inform the user that the server 230 in the standby state is about to enter the shutdown state.

In block S25, the server 230 in the first state is controlled to enter a second state.

In the embodiment, if the time when the server 230 is in the first state reaches the preset time, the energy saving system 10 will control the server 230 in the first state to enter the second state.

The second state may be a shutdown state, the energy saving system 10 turns off the power of the server 230 in the standby state, whereby the energy saving system 10 can control the server 230 in the standby state to enter the shutdown status. At this time, the server 230 in the shutdown state will consume no power. Next, the energy saving system 10 will also output a prompt information to inform the user that the server 230 enters the shutdown state.

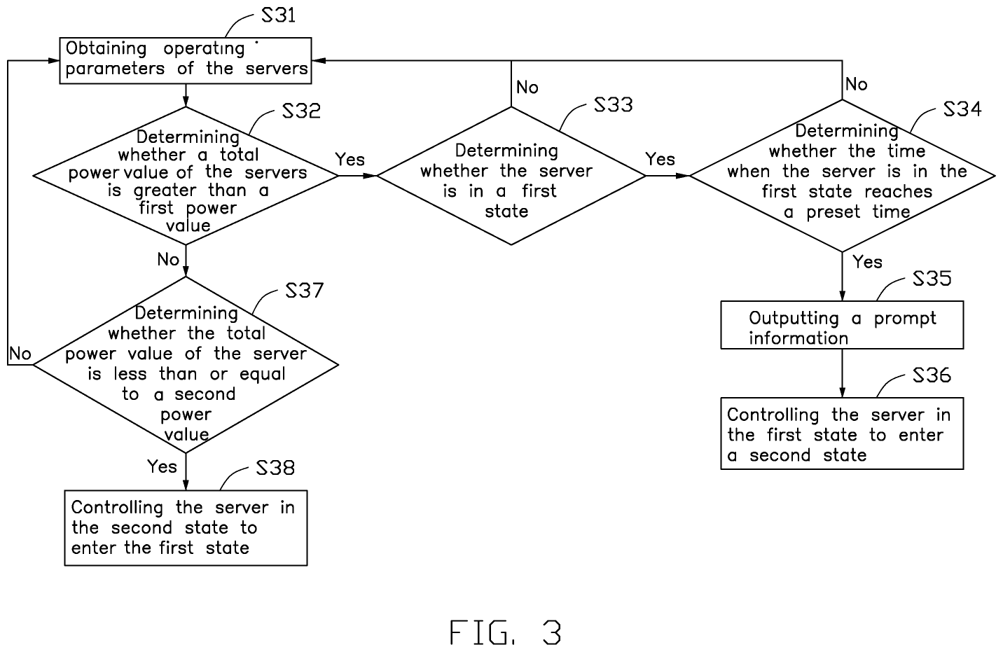

FIG. 3 illustrates a flowchart of another embodiment of a method for saving energy. The method for saving energy may include the following steps.

In block S31, the operating parameters of the servers 230 are obtained.

In the embodiment, the energy saving system 10 will obtain the operating parameters of the server 230 and be able to display these operating parameters in real time.

In block S32, whether a total power value being consumed by the servers 230 is greater than a first power value is determined. If the total power value of the servers 230 is greater than the first power value, block S33 is implemented, otherwise block S37 is implemented.

In the embodiment, the energy saving system 10 obtains the total power consumption of the cabinet 210 according to the operating parameters, and compares the total power value with the first power value.

In the embodiment, the first power value can be an upper limit.

In block S33, whether the server 230 is in the first state is determined. If the server 230 is in the first state, block S34 is implemented, otherwise returns to block S31.

In the embodiment, the energy saving system 10 only determines whether the server 230 is in a standby state when the total power value of the cabinet 210 exceeds the first power value.

In block S34, whether the length of time for which the server 230 being in the first state reaches a preset time is determined. If the length of time for which the server 230 being in the first state reaches the preset time, block S35 is implemented, otherwise returns to block S31.

The energy saving system 10 determines whether the amount of time when the server 230 is in the standby state reaches the preset time, for example, the energy saving system 10 can determine whether the time of the server 230 being in the standby state reaches 12 hours. If the length of time for which the server 230 being in the standby state does not reach 12 hours, the energy saving system 10 will need to obtain the operating parameters of the server 230 again. That is, the energy saving system 10 can obtain the latest operating status of the server 230 of the data center 200.

In block S35, a prompt information is outputted.

In the embodiment, the energy saving system 10 will output the prompt information to inform the user that the server 230 in the standby state is about to enter the shutdown state.

In block S36, the server 230 in the first state is controlled to enter the second state.

In the embodiment, if the length of time for which the server 230 being in the first state reaches the preset time, the energy saving system 10 will control the server 230 in the first state to enter the second state.

The second state is a shutdown state. The energy saving system 10 turns off the power of the server 230 in the standby state, whereby the energy saving system 10 can control the server 230 in the standby state to enter a shutdown state. At this time, the server 230 in the shutdown state will consume no power. Next, the energy saving system 10 will also output a prompt information to inform the user that the server 230 enters the shutdown state.

In block S37, whether the value of total power being consumed by the servers 230 is less than or equal to a second power value is determined. If the value of total power being consumed by the servers 230 is less than or equal to the second power value, block S38 is implemented, otherwise returns to block S31.

In the embodiment, the energy saving system 10 compares the value of total power being consumed by the servers 230 with the second power value. If the value of total power being consumed by the servers 230 is greater than the second power value and less than the first power value, the energy saving system 10 obtains the operating parameters of the server 230, and displays these operating parameters.

In block S38, the server 230 in the second state is controlled to enter the first state.

In the embodiment, if the value of total power being consumed by the servers 230 is less than or equal to the second power value, the value of total power being consumed by the data center 200 is lower than the upper limit value and the normal value, the data center 200 at this time can increase the number of servers 230 to participate in data processing. The energy saving system 10 will control the server 230 in the second state to enter the first state. Therefore, the energy saving system 10 turns on the power of the server 230 in the shutdown state, to control the server 230 in the shutdown state to resume the standby state, and outputs a prompt information to notify the user that the server 230 in the shutdown state has entered the standby state.

The above two different embodiments of the energy saving method can be implemented separately, or the second embodiment can be optimized from the first embodiment, or can be applied together in the energy saving device 100, and a person skilled in the art can freely select one of them for energy saving operation to achieve the purpose of saving electric energy. In the embodiment, the operating status of the system in the server 230 of the cabinet 210 can be monitored in real time according to the energy saving system 10, and energy saving operations can be taken when energy saving is needed, to avoid waste of electrical energy.

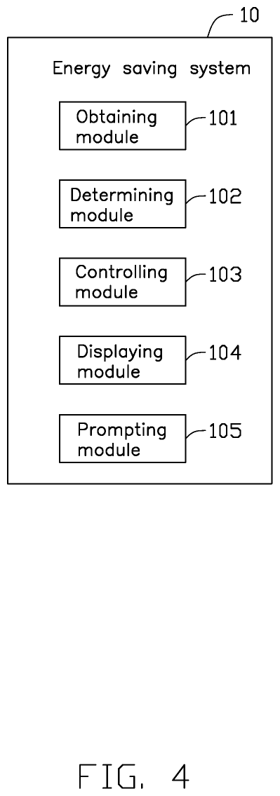

Referring to FIG. 4, in at least one embodiment, the energy saving system 10 may be divided into one or more modules, and the one or more modules are stored in the storage device 11 and executed by the processor 12. The one or more modules may be a series of computer program instruction segments capable of performing specific functions, and the instruction segments are for the execution process of the energy saving system 10 in the energy saving device 100. For example, the energy saving system 10 may be divided into an obtaining module 101, a determining module 102, a controlling module 103, a displaying module 104, and a prompting module 105, as show in FIG. 4.

In at least one embodiment, the obtaining module 101 can obtain the operating parameters of the servers 230.

In at least one embodiment, the determining module 102 can determine whether the server 230 is in the first state according to the operation parameters. The determining module 102 also can determine whether the length of time that the server 230 has been in the first state reaches a preset time.

In at least one embodiment, the controlling module 103 can control the server 230 in the first state to enter the second state.

In at least one embodiment, the displaying module 104 can display the operating parameters of the server 230, users can quickly find the server 230 according to the IP address and name displayed by the displaying module 104. The displaying module 104 displays the location and path information of all servers 230. Therefore, the user can timely find a server 230 that needs the energy saving operation according to the information. In the embodiment, the displaying module 104 also displays the time when the system event occurs. For example, it shows that at a certain time, the system power is turned off. In this embodiment, the upper limit value and the lower limit value of the power are set by the users according to the requirements of the server 230.

The user can also set the preset time manually on the energy saving device 100. When the time when the system added to the server 230 is in the standby state reaches the preset time, the energy saving device 100 automatically controls to turn off the power of the server 230 that meets the conditions.

The prompting module 105 can output prompt information to the user.

The determining module 102 can determine whether the total power of the server 230 is greater than the first power value, and whether the total power of the server 230 is less than or equal to the second power value.

The controlling module 103 is also used to control the server 230 in the second state to enter the first state.

Therefore, the power consumption of the data center 200 can be reduced to achieve the purpose of saving energy. For specific content, refer to the above energy saving method, which will not be detailed here.

In the embodiment, the storage device 11 may be an internal storage device of the energy saving device 100, and a storage device built in the energy saving device 100. In other embodiments, the storage device 11 may also be an external storage device of the energy saving device 100, and a storage device externally connected to the energy saving device 100.

In the embodiment, the storage device 11 is used to store program codes and various data, for example, store the program codes of the energy saving system 10 installed in the energy saving device 100. For example, in the embodiment, the energy saving system 10 is used to determine whether the server 230 is in the first state according to the operating parameters, and control the server 230 in the first state to enter the second state.

The storage may include random access memory, as well as non-volatile memory, such as hard drives, memory, plug-in hard drives, smart media card, secure digital, SD card, Flash Card, at least one disk memory, flash device.

In at least one embodiment, the processor 12 can be a central processing unit (CPU), or can be other general-purpose processor, digital signal processor (DSPs), and application specific integrated circuit (ASIC), Field-Programmable Gate Array (FPGA), or other programmable logic device, discrete gate, or transistor logic device, or discrete hardware component, etc.. The processor 12 can be a microprocessor, or the processor 12 can be any conventional processor.

When the modules/units integrated in the energy saving system 10 are implemented in the form of software functional units of independent or standalone products, they can be stored in a non-transitory readable storage medium. Based on this understanding, all or part of the processes in the methods of the above embodiments implemented by the present disclosure can also be completed by related hardware instructed by computer-readable instructions. The computer-readable instructions can be stored in a non-transitory readable storage medium. The computer-readable instructions, when executed by the processor, may implement the steps of the foregoing method embodiments. The computer-readable instructions include computer-readable instruction codes, and the computer-readable instruction codes can be in a source code form, an object code form, an executable file, or some intermediate form. The non-transitory readable storage medium can include any entity or device capable of carrying the computer-readable instruction code, a recording medium, a U disk, a mobile hard disk, a magnetic disk, an optical disk, a computer memory, a read-only memory (ROM).

Understandably, the module division described above is a logical function division, the actual implementation of division can be in other way. In addition, each function module in each embodiment of this application may be integrated into the same processing unit, or the individual modules may be physically present, or two or more modules may be integrated in the same cell. The above integrated module can be implemented in the form of hardware, or in the form of hardware plus software function module.

Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

1. An energy saving method for an energy saving device, applicable in the energy saving device configured to enable the energy saving to communicate with a plurality of servers, a storage device, and a processor, the method comprising:
obtaining operating parameters of the servers;
determining whether the server is in a first state according to the operating parameters; and
controlling the server in the first state to enter a second state;
determining whether a length of time for which the server being in the first state reaches a preset time;
controlling the server in the first state to enter the second state if the time when the server is in the first state reaches the preset time; and obtaining the operating parameters of the servers again if the time when the server is in the first state does not reach the preset time.

2. (canceled)

3. The energy saving method according to claim 1, further comprising:
outputting prompt information to a user when the server in the first state enters the second state.

4. The energy saving method according to claim 1, further comprising:
the processor determining whether a total power value being consumed by the servers is greater than a first power value;
determining whether the server is in the first state when the value of total power being consumed by the servers is greater than the first power value;
determining whether a length of time for which the server being in the first state reaches a preset time if the server is in the first state; and
controlling the server in the first state to enter the second state if the time when the server is in the first state reaches the preset time.

5. The energy saving method according to claim 4, further comprising:
determining whether the total power value being consumed by the servers is less than or equal to a second power value if the total power value being consumed by the servers is less than the first power value; and
controlling the server in the second state to enter the first state if the total power value being consumed by the servers is less than the second power value.

6. The energy saving method according to claim 1, wherein the first state is a standby state, and the second state is a shutdown state.

7. The energy saving method according to claim 1, wherein the operating parameters comprise power, IP address, host name list, power status, and system usage of each server.

8. The energy saving method according to claim 7, wherein the system usage comprises CPU utilization, available storage device value, disk utilization, and rate of the network sending or receiving data.

9. The energy saving method according to claim 8, wherein when the CPU utilization of the server is less than 10%, the available storage device value is greater than 90%, the disk utilization is less than 10%, and the rate of the network sending or receiving data is less than 10MB/s, the processor determines the server is in the first state.

10. The energy saving method according to claim 1, wherein the preset time is 12 hours.

11. An energy saving device communicating with a plurality of servers and comprising:
a storage device; and a processor;
wherein the storage device stores one or more programs, which when executed by the processor, cause the processor to:
obtain operating parameters of the servers;
determine whether the server is in a first state according to the operating parameters;
control the server in the first state to enter a second state;
determine whether a length of time for which the server being in the first state reaches a preset time;
control the server in the first state to enter the second state if the time when the server is in the first state reaches the preset time; and obtain the operating parameters of the servers again if the time when the server is in the first state does not reach the preset time.

12. (canceled)

13. The energy saving device according to claim 11, wherein the processor is further caused to:
output prompt information to a user when the server in the first state enters the second state.

14. The energy saving device according to claim 11, wherein the processor is further caused to:
determine whether a total power value being consumed by the servers is greater than a first power value;
determine whether the server is in the first state when the total power value being consumed by the servers is greater than the first power value;
determine whether a length of time for which the server being in the first state reaches a preset time if the server is in the first state; and
control the server in the first state to enter the second state if the time when the server is in the first state reaches the preset time.

15. The energy saving device according to claim 14, wherein the processor is further caused to:
determine whether the value of total power being consumed by the servers is less than or equal to a second power value if the total power value of the servers is less than the first power value; and
control the server in the second state to enter the first state if the total power value of the servers is less than the second power value.

16. The energy saving device according to claim 11, wherein the first state is a standby state, and the second state is a shutdown state.

17. The energy saving device according to claim 11, wherein the operating parameters comprise power, IP address, host name list, power status, and system usage of each server.

18. The energy saving device according to claim 17, wherein the system usage comprises CPU utilization, available storage device value, disk utilization, and rate of the network sending or receiving data.

19. The energy saving device according to claim 18, wherein when the CPU utilization of the server is less than 10%, the available storage device value is greater than 90%, the disk utilization is less than 10%, and the rate of the network sending or receiving data is less than 10MB/s, the processor determines the server is in the first state.

20. The energy saving device according to claim 11, wherein the preset time is 12 hours.
